(19) United States
(12) Patent Application Publication
(10) Pub. No.: US 2022/0109900 A1
(43) Pub. Date: Apr. 7, 2022

(54) SYSTEM FOR INTERMEDIATING VIRTUAL IMAGE, DEVICE FOR INSERTING VIRTUAL IMAGE, AND METHOD FOR OPERATING SAME

(71) Applicant: SAMSUNG ELECTRONICS CO., LTD., Suwon-si (KR)

(72) Inventors: Hyungyeol LEE, Suwon-si (KR); Jeongdon KANG, Suwon-si (KR); Changwon NAM, Suwon-si (KR); Bonghoon PARK, Suwon-si (KR); Kyuha CHOI, Suwon-si (KR)

(73) Assignee: SAMSUNG ELECTRONICS CO., LTD., Suwon-si (KR)

(21) Appl. No.: 17/419,149

(22) PCT Filed: Nov. 1, 2019
(86) PCT No.: PCT/KR2019/014651

§ 371 Date: Jun. 28, 2021

(30) Foreign Application Priority Data
Dec. 26, 2018 (KR) 10-2018-0169524

(51) Int. Cl. H04N 21/2668; H04N 21/81; H04N 21/234

(52) U.S. Cl. CPC H04N 21/2668; H04N 21/23424; H04N 21/812

(57) ABSTRACT

The present disclosure relates to a system for intermediating a virtual image, the system including: a communicator configured to receive, from a first device, user information and information about broadcast content into which a virtual image is to be inserted and receive virtual images from a second device; a memory storing one or more instructions; and a processor configured to execute the one or more instructions stored in the memory to: determine, based on the user information and the information about the broadcast content, one or more virtual images that are insertable into the broadcast content from among the virtual images; and control the determined one or more virtual images to be transmitted to the first device.

### TECHNICAL FIELD

Various embodiments relate to a system for intermediating a virtual image, a device for inserting a virtual image, and operating methods thereof, and more particularly, to a system for intermediating a virtual image to be inserted into broadcast content between a broadcaster and either an advertiser or viewer and an operation method thereof. Furthermore, they relate to a device for inserting a virtual image into broadcast content streamed in real-time and an operation method thereof.

### BACKGROUND ART

Due to the spread of personal computers (PCs) and the commercialization of ultra-high-speed Internet, a real-time broadcasting environment has been established, and with the emergence of services that enable real-time broadcasting, a market for personal real-time broadcasting is rapidly growing.

A broadcaster is a person who produces broadcast content and provides it to viewers, and generally refers to a creator who produces and uploads videos. In real-time personal broadcasting, a broadcaster and a viewer are able to communicate in real-time, a chat window is activated during a broadcasting time, and a viewer's opinion in the form of a comment may be immediately reflected in the broadcast. Furthermore, to interact with a broadcaster, a viewer may sponsor a broadcaster (e.g., a creator) by making a payment during real-time broadcasting.

Moreover, broadcast content may provide a virtual advertisement using a virtual imaging technique by which an advertisement image is inserted in real-time into a specific space or a virtual space during live broadcasting so that the advertisement image is processed as if it is actually included in a corresponding image screen. Accordingly, in the market for real-time personal broadcasting, the size of the advertising market is rapidly increasing.

### DESCRIPTION OF EMBODIMENTS

### Technical Problem

Various embodiments may provide a system capable of intermediating an advertisement image to be inserted into broadcast content between a broadcaster and an advertiser, and intermediating a virtual image to be inserted into broadcast content between a broadcaster and a viewer, and an operation method thereof.

In addition, the embodiments may provide a device capable of inserting a virtual image according to a region of which a location and a shape are transformed in real-time, and an operation method thereof.

### Advantageous Effects of Disclosure

A system according to an embodiment may provide an advertisement to a viewer via broadcast content by intermediating an advertisement image between a broadcaster and an advertiser.

The system according to the embodiment may enhance an interaction between a broadcaster and a viewer by intermediating a virtual image to be inserted into broadcast content between the broadcaster and the viewer.

The system according to an embodiment may be used as a means for creating new profits for a broadcaster by intermediating a virtual image to be inserted into broadcast content between the broadcaster and a viewer.

By inserting an advertisement image or a virtual image or advertisement image requested by a viewer into a region that is transformed in real-time, a device according to an embodiment may improve a sense of reality with regard to the inserted image.

### BRIEF DESCRIPTION OF DRAWINGS

FIG. 1 is a diagram illustrating a system for intermediating a virtual image according to an embodiment.

FIG. 2 is a block diagram of a configuration of a virtual image intermediating system according to an embodiment, and FIG. 3 is a block diagram of a configuration of a processor of FIG. 2.

FIG. 4 is a block diagram of a configuration of a first device according to an embodiment, FIG. 5 is a block diagram of a configuration of a processor of FIG. 4, and FIG. 6 is a block diagram of a configuration of an insertion region determiner of FIG. 5.

FIG. 7 is a flowchart of a method of inserting a virtual image into broadcast content, according to an embodiment.

FIG. 8 is a flowchart of a method, performed by a virtual image intermediating system, of intermediating a virtual image, according to an embodiment.

FIG. 9 is a flowchart of a method, performed by a first device, of inserting a virtual image into broadcast content, according to an embodiment.

FIG. 10 is a reference diagram for describing an insertion region into which a virtual image is inserted, according to an embodiment.

FIG. 11 is a reference diagram for describing a method of determining a virtual image to be inserted into an insertion region, according to an embodiment.

FIG. 12 is a reference diagram for describing a method of performing a real-time interaction between a broadcaster and a viewer by using a virtual image intermediating system, according to an embodiment.

### BEST MODE

A system for intermediating a virtual image according to an embodiment includes: a communicator configured to receive, from a first device, user information and information about broadcast content into which a virtual image is to be inserted and receive virtual images from a second device; a memory storing one or more instructions; and a processor configured to execute the one or more instructions stored in the memory to: determine, based on the user information and the information about the broadcast content, one or more virtual images that are insertable into the broadcast content from among the virtual images; and control the determined one or more virtual images to be transmitted to the first device.

According to an embodiment, the virtual images may include at least one of an advertisement image transmitted by an advertiser and an image transmitted by a viewer who watches the broadcast content.

According to an embodiment, the processor may be further configured to determine whether the advertisement image is insertable into the broadcast content, based on advertiser information and advertisement image information corresponding to the advertisement image.

According to an embodiment, the processor may be further configured to determine, based on information about the one or more virtual images that are insertable into the broadcast content, a rating of the one or more virtual images, and transmit information about the rating of the one or more virtual images to the first device.

According to an embodiment, the processor may be further configured to determine a rating of the advertisement image based on the advertiser information and advertisement image information corresponding to the advertisement image.

According to an embodiment, the processor may be further configured to determine a rating of the image transmitted by the viewer based on payment information corresponding to the image transmitted by the viewer.

An operation method of a system for intermediating a virtual image, according to an embodiment, includes: receiving, from a first device, user information and information about broadcast content into which a virtual image is to be inserted; receiving virtual images from a second device; determining, based on the user information and the information about the broadcast content, one or more virtual images that are insertable into the broadcast content from among the virtual images; and transmitting the determined one or more virtual images to the first device.

A device for inserting a virtual image according to an embodiment includes: a communicator configured to receive, from an external device, virtual images and information about the virtual images; a memory storing one or more instructions; and a processor configured to execute the one or more instructions stored in the memory to: obtain, from each of frames included in broadcast content, information about an insertion region set on an object that is transformed in real-time; determine, based on the information about the virtual images, one or more virtual images that are to be inserted into the insertion region from among the virtual images; and insert the one or more virtual images into each of the frames based on the information about the insertion region, wherein the insertion region has a different shape and a different position for each of the frames.

According to an embodiment, the processor may be further configured to insert the one or more virtual images into each of the frames in real-time.

According to an embodiment, the processor may be further configured to determine, based on a user input, the one or more virtual images to be inserted into the insertion region from among the virtual images.

According to an embodiment, the processor may be further configured to determine, based on the information about the virtual images, a priority of the one or more virtual images and insert the one or more virtual images into each of the frames based on the priority.

According to an embodiment, the processor may be further configured to extract, from each of the frames, at least one feature point included in the insertion region, obtain three-dimensional (3D) coordinate information corresponding to the insertion region based on the at least one feature point, and insert the one or more virtual images into the insertion region based on the 3D coordinate information.

According to an embodiment, the communicator may transmit in real-time the frames into which the virtual images are inserted to a broadcast content server.

An operation method of a device for inserting a virtual image, according to an embodiment, includes: receiving, from an external device, virtual images and information about the virtual images; obtaining, from each of frames included in broadcast content, information about an insertion region set on an object that is transformed in real-time; determining, based on the information about the virtual images, one or more virtual images that are to be inserted into the insertion region from among the virtual images; and inserting the one or more virtual images into each of the frames based on the information about the insertion region, wherein the insertion region has a different shape and a different position for each of the frames.

### Mode of Disclosure

Terms used in the present specification will now be briefly described and then the present disclosure will be described in detail.

As the terms used herein, general terms that are currently widely used are selected by taking functions in the present disclosure into account, but the terms may have different meanings according to an intention of one of ordinary skill in the art, precedent cases, advent of new technologies, etc. Furthermore, specific terms may be arbitrarily selected by the applicant, and in this case, the meaning of the selected terms will be described in detail in the detailed description of the disclosure. Thus, the terms used herein should be defined not by simple appellations thereof but based on the meaning of the terms together with the overall description of the present disclosure.

Throughout the specification, when a part “includes” or “comprises” an element, unless there is a particular description contrary thereto, the part may further include other elements, not excluding the other elements. Furthermore, terms, such as “portion,” “module,” etc., used herein indicate a unit for processing at least one function or operation and may be embodied as hardware or software or a combination of hardware and software.

Embodiments will now be described more fully hereinafter with reference to the accompanying drawings so that they may be easily implemented by one of ordinary skill in the art to which the present disclosure belongs. However, the present disclosure may have different forms and should not be construed as being limited to the embodiments set forth herein. Parts not related to descriptions of the present disclosure are omitted to clearly explain the present disclosure in the drawings, and like reference numerals denote like elements throughout.

In the embodiments of the present specification, the term “user” may refer to a person who controls a system, a function, or an operation, and include a developer, a manager, or an installation engineer.

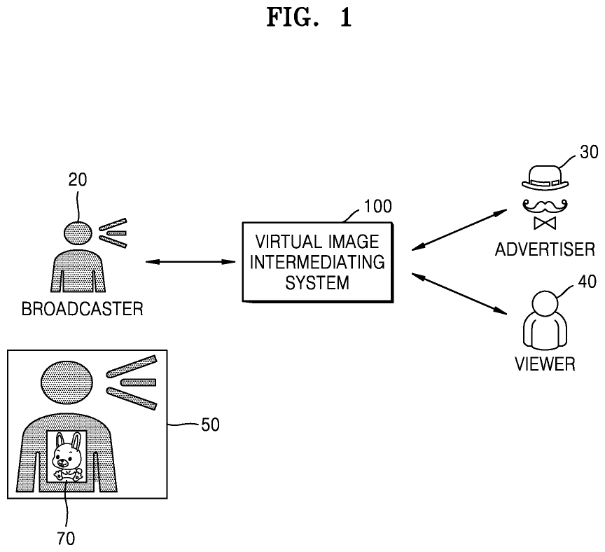

FIG. 1 is a diagram illustrating a system for intermediating a virtual image according to an embodiment.

A virtual image intermediating system 100 according to an embodiment may be a system that connects a broadcaster 20 to an advertiser 30 or a viewer 40. The broadcaster 20 is a person who produces broadcast content 50 and provides it to the viewer 40, and may generally mean a creator who produces and uploads a video. For example, the broadcaster 20 may include a creator who makes a one-person broadcast, but the present disclosure is not limited thereto. In a one-person broadcast, a creator communicates with a viewer in real-time. For example, a chat window may be activated during a broadcast time, and a viewer's opinion as a comment may be immediately reflected in a broadcast.

According to an embodiment, a virtual image 70 transmitted (uploaded) by the advertiser 30 or the viewer 40 may be inserted into the broadcast content 50. For example, the virtual image 70 may include, but is not limited to, an advertisement image transmitted by the advertiser 30 or an image transmitted by the viewer 40, and may include an image uploaded by a broadcaster 20. Furthermore, the virtual image 70 may include not only content in an image format but also content in various formats, such as a video, a text, etc.

Moreover, the advertiser 30 is a leading entity who performs advertising activities, and means a person who publishes an advertisement. The advertiser 30 may include an individual, a corporation, a company, etc., but is not limited thereto. According to an embodiment, the broadcast content 50 may serve as a medium into which an advertisement image transmitted by the advertiser 30 is inserted so that details of the advertisement are conveyed to a consumer (e.g., the viewer 40).

In addition, the viewer 40 refers to a person who views the broadcast content 50 produced by the broadcaster 20, and an image transmitted by the viewer 40 may be inserted into the broadcast content 50. Accordingly, a real-time interaction between the broadcaster 20 and the viewer 40 may be further strengthened.

According to an embodiment, the virtual image intermediating system 100 may provide the broadcaster 20 with a virtual image insertion software for inserting a virtual image into broadcast content. By using the virtual image insertion software, the broadcaster 20 may easily insert a virtual image received from the virtual image intermediating system 100 or a virtual image uploaded by the broadcaster 20 into each of the frames included in broadcast content. According to an embodiment, a region into which the virtual image 70 is inserted may be set on an object that is transformed in real-time, and a location and a shape of the object may vary for each frame included in broadcast content.

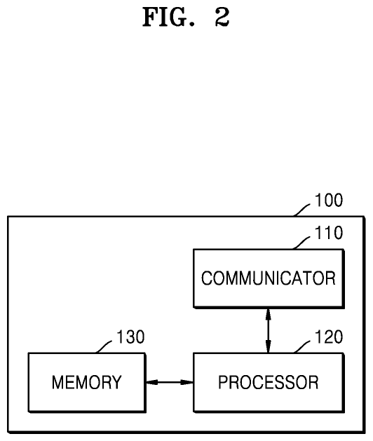

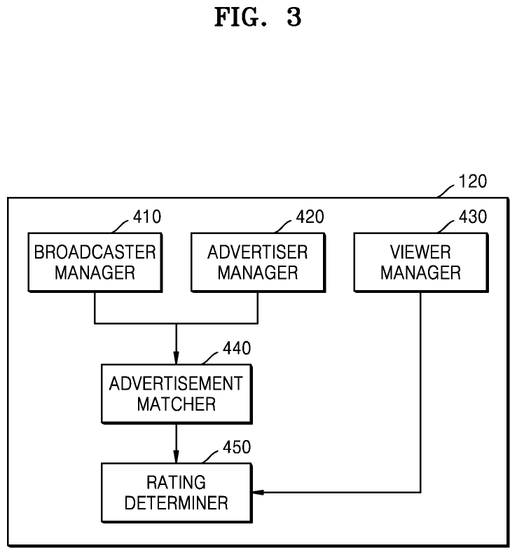

FIG. 2 is a block diagram of a configuration of a virtual image intermediating system according to an embodiment, and FIG. 3 is a block diagram of a configuration of a processor of FIG. 2.

Referring to FIG. 2, a virtual image intermediating system 100 according to an embodiment may include a communicator 110, a memory 130, and a processor 120.

According to an embodiment, the processor 120 may control the virtual image intermediating system 100 in its entirety. The processor 120 may execute one or more programs stored in the memory 130.

The communicator 110 may transmit and receive data or signals to and from an external device or an external server according to control by the processor 120.

The communicator 110 may include one or more components that enable communication via a local area network (LAN), a wide area network (WAN), a value added network (VAN), a mobile radio communication network, a satellite communication network, and combinations thereof. Furthermore, the communicator 110 may wirelessly transmit and receive data or signals directly to and from an external device or an external server by using a wireless LAN (e.g., Wi-Fi), etc.

According to an embodiment, the communicator 110 may distribute a virtual image embedding software to a first device via a network. Here, the first device may be a device used by a broadcaster to produce broadcast content.

Furthermore, the communicator 110 may receive, from the first device, information of a broadcaster and information about broadcast content into which a virtual image is to be inserted. The information about the broadcast content may include at least one of a type of the broadcast content, information about a category of the broadcast content, information about a target user of the broadcast content, and information about the number of viewers of the broadcast content.

The communicator 110 may also receive a virtual image from a second device. Here, the second device is a device used by advertisers to transmit (upload) advertisement images (advertising content) to the virtual image intermediating system 100, or a device used by a viewer to transmit (upload) the virtual image to the virtual image intermediating system 100 while viewing broadcast content. Alternatively, the second device may be a device on which a web page provided by the virtual image intermediating system 100 according to an embodiment is displayed.

According to an embodiment, the memory 130 may store various pieces of data, programs, or applications for driving and controlling the virtual image intermediating system 100. In addition, the memory 130 may store information about broadcast content and a broadcaster registered in the virtual image intermediating system 100, information about an advertiser and an advertisement image (advertising content), and information about a viewer and an image transmitted by the viewer. A program stored in the memory 130 may include one or more instructions. A program (one or more instructions) or an application stored in the memory 130 may be executed by the processor 120.

Referring to FIG. 3, the processor 120 according to an embodiment may include a broadcaster manager 410, an advertiser manager 420, a viewer manager 430, an advertisement matcher 440, and a rating determiner 450.

The broadcaster manager 410 may manage information about a broadcaster and information about broadcast content. For example, the broadcaster manager 410 may control information of a broadcaster and information about broadcast content that is broadcast by the broadcaster (e.g., a type of broadcast content, category information thereof, and information about a target user of the broadcast content, information about the number of viewers of the broadcast content, etc.), which are received from the first device, to be mapped to each other and stored in the memory 130.

Furthermore, the broadcaster manager 410 may determine a rating of the broadcaster or broadcast content. For example, the broadcaster manager 410 may assign a higher rating to a broadcaster or broadcast content as more viewers watch the broadcast content broadcast by the broadcaster. In addition, the broadcaster manager 410 may classify broadcast content into categories (e.g., a game broadcast, a music broadcast, a food broadcast, etc.).

When a broadcaster logs in to the virtual image intermediating system 100, the broadcaster manager 410 may extract information about the broadcaster and broadcast content corresponding to login identification information.

The advertiser manager 420 may manage information about an advertiser and an advertisement image (content). The advertiser manager 420 may determine an advertiser's rating based on information of the advertiser. For example, the advertiser manager 420 may determine an advertiser's rating according to an awareness level of the advertiser company and a size of the company, and the larger the company and the higher the cost paid by the company, the higher the rating given to the advertiser. In addition, the advertiser manager 420 may classify advertisement images (content) transmitted by the advertiser into categories (e.g., categories of advertisement objects to be advertised via advertisement images).

The advertisement matcher 440 may match at least one advertisement image with broadcast content. For example, the advertisement matcher 440 may determine an advertisement image matched with broadcast content, based on rating information of a broadcaster, rating information of an advertiser, category information of the broadcast content, and category information of an advertisement image.

For example, when the number of viewers of broadcast content is greater than or equal to a preset number, the advertisement matcher 440 may match an advertisement image for an advertiser which is at a large company level with the broadcast content, and when the broadcast content is a food broadcast, the advertisement matcher 440 may match an advertisement image for food with the broadcast content. However, the present disclosure is not limited thereto, and advertisement images may be matched with broadcast content in various ways.

The viewer manager 430 may store, in a memory, information about a viewer and a virtual image transmitted by the viewer for management. The viewer manager 430 may obtain information about broadcast content currently being viewed by the viewer and match an image transmitted by the viewer with the broadcast content currently being viewed by the viewer. Furthermore, the viewer manager 430 may determine a viewer's rating based on information about the viewer, and manage payment information corresponding to a virtual image uploaded by the viewer.

The rating determiner 450 may determine ratings for advertisement images matched with broadcast content being broadcast by a broadcaster and virtual images transmitted by a viewer (hereinafter, referred to as viewer images). For example, the rating determiner 450 may determine ratings for advertisement images based on advertising fee information corresponding to each of the advertisement images, rating information of an advertiser, category information of each advertisement image, etc. However, the present disclosure is not limited thereto.

Furthermore, the rating determiner 450 may determine ratings for viewer images based on rating information and payment information of a viewer, which correspond to each of the viewer images, but the present disclosure is not limited thereto.

Referring back to FIG. 2, the communicator 110 may transmit, to the first device, viewer images and advertisement images matched with broadcast content. Furthermore, the communicator 110 may transmit, together therewith, information about ratings of the advertisement images and viewer images, which are determined by the rating determiner 450.

Moreover, the block diagram of the virtual image intermediating system 100 and the block diagram of the processor 120 respectively shown in FIGS. 2 and 3 are provided for illustration of an embodiment. Each of the components in each block diagram may be integrated, added, or omitted according to the specification of the virtual image intermediating system 100 that is actually implemented. In other words, two or more components may be combined into a single component, or a single component may be split into two or more components when necessary. Functions performed by each block are intended to describe embodiments, and a specific operation or device related to the functions does not limit the scope of the present disclosure.

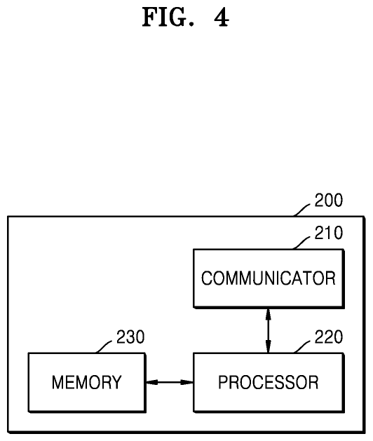

FIG. 4 is a block diagram of a configuration of a first device according to an embodiment, FIG. 5 is a block diagram of a configuration of a processor of FIG. 4, and FIG. 6 is a block diagram of a configuration of an insertion region determiner of FIG. 5.

Referring to FIG. 4, a first device 200 according to an embodiment may include a communicator 210, a memory 230, and a processor 220.

According to an embodiment, the first device 200 may be a device used by a broadcaster to produce broadcast content or a virtual image insertion device for inserting a virtual image.

The first device 200 may include a mobile phone, a smart phone, a laptop computer, a desktop computer, a tablet PC, an electronic book (e-book) terminal, a digital broadcasting terminal, a personal digital assistant (PDA), a portable multimedia player (PMP), a navigation device, an MP3 player, a camcorder, an Internet Protocol television (IPTV), a digital TV (DTV), a wearable device, etc., but are not limited thereto. For example, a broadcaster (a first device user) may use a web service provided by the virtual image intermediating system 100 by using the first device 200.

According to an embodiment, the processor 220 may control the first device 200 in its entirety. The processor 220 may execute one or more programs stored in the memory 230.

The communicator 210 may transmit and receive data or signals to and from an external device or an external server according to control by the processor 220.

The communicator 210 may include one or more components that enable communication via a LAN, a WAN, a VAN, a mobile radio communication network, a satellite communication network, and combinations thereof. Furthermore, the communicator 210 may wirelessly transmit and receive data or signals directly to and from an external device or an external server by using a wireless LAN (e.g., Wi-Fi), etc.

According to an embodiment, the communicator 210 may download virtual image embedding software from the virtual image intermediating system 100 via a network. However, it is not limited thereto,

The communicator 210 may transmit, from the virtual image intermediating system 100, information of a broadcaster and information about broadcast content into which a virtual image is to be inserted. In addition, the communicator 210 may receive viewer images and advertisement images matched with the broadcast content from the virtual image intermediating system 100.

According to an embodiment, the memory 230 may store various pieces of data, programs, or applications for driving and controlling the first device 200. The memory 230 may also store a virtual image uploaded by the broadcaster. A program stored in the memory 230 may include one or more instructions. A program (one or more instructions) or an application stored in the memory 230 may be executed by the processor 220.

Referring to FIG. 5, the processor 220 may include an insertion region determiner 510, a virtual image determiner 520, and a virtual image inserter 530. The insertion region determiner 510 may extract, based on information about an insertion region, an insertion region into which a virtual image is to be inserted from each of the frames included in broadcast content, and obtain three-dimensional (3D) coordinates that are matched with the extracted insertion region.

The insertion region determiner 510 will be described in detail with reference to FIG. 6.

The insertion region determiner 510 may include a frame buffer 610, a frame adjuster 620, a feature point extractor 630, a first buffer 635, a feature point matcher 640, a feature point learner 642, and a feature point tracker 660, a second buffer 645, and a 3D coordinate synthesizer 650.

The frame buffer 610 may receive and store image frames included in broadcast content. In this case, the image frames stored in the frame buffer 610 may be high-quality image frames (e.g., image frames having a full high definition (FHD) or higher resolution). By storing image frames in the frame buffer 610, loss of the image frames may be prevented.

The frame adjuster 620 may receive image frames from the frame buffer 610 and decrease a resolution of the received image frames to a preset resolution for real-time processing. For example, the frame adjuster 620 may decrease the resolution of the image frames to an HD-level resolution or lower.

The feature point extractor 630 may extract feature points from each of the image frames having an adjusted resolution. For example, the feature point extractor 630 may extract, as a feature point, a point in an image frame showing a brightness change in all directions around the point, and obtain two-dimensional (2D) coordinates of the extracted feature point and information about its surroundings. The 2D coordinates of the extracted feature point and the information about its surroundings may be stored in the first buffer 635. The 2D coordinates of the extracted feature point and the information about its surroundings may be stored in the first buffer 635 so that even when calculations in the feature point matcher 640 and the feature point tracker 660 are not finished, the feature point extractor 630 may continuously perform a calculation without waiting for those calculations to be finished.

The feature point matcher 640 may map a feature point extracted by the feature point extractor 630 to a most similar feature point among feature points included in a pre-learned template image. Moreover, the feature point learner 642 may learn a template image. For example, after obtaining a template image used as a reference (a reference template image), the feature point learner 642 may extract feature points from the reference template image, generate new reference images by performing affine transformation of the reference template image into various arbitrary forms, extract feature points from the new template images, and learn 3D coordinate information of the extracted feature points.

The feature point matcher 640 may match feature points extracted from an image frame to feature points in the learned template image.

The feature point tracker 660 may track positions in a current frame, corresponding to feature points extracted from a previous frame, and match, based on information about matching between the feature points extracted from the previous frame and feature points in a template image, corresponding feature points in the current frame to the feature points in the template image.

Moreover, first matching information regarding matching between the feature points in the current frame and the feature points in the template image, which is obtained by the feature point matcher 640, and second matching information regarding matching between the feature points in the current frame and the feature points in the template image, which are obtained by the feature point tracker 660, may be stored in the second buffer 645. The first matching information and the second matching information may be stored in the second buffer 645 so that even when a calculation in the 3D coordinate synthesizer 650 is not finished, the feature point matcher 640 and the feature point tracker 660 may continuously perform calculations without waiting for that calculation to be finished.

The 3D coordinate synthesizer 650 may obtain 3D coordinate information (e.g., 3D mesh coordinates) for an insertion region in the current frame based on the first matching information regarding matching between the feature points in the current frame and the feature points in the template image, which is obtained by the feature point matcher 640, and the second matching information regarding matching between the feature points in the current frame and the feature points in the template image, which are obtained by the feature point tracker 660.

The virtual image determiner 520 may determine a virtual image to be inserted into the insertion region. For example, the virtual image determiner 520 may determine an image to be inserted into a broadcast content frame from among advertisement images and viewer images received from the virtual image intermediating system 100 and virtual images uploaded by a broadcaster.

The virtual image determiner 520 may determine an image to be inserted into a frame based on a selection input by the broadcaster. Alternatively, the virtual image determiner 520 may determine an image to be inserted into the frame based on image information regarding the virtual images. For example, the virtual image determiner 520 may determine priorities of the virtual images based on rating information of the virtual images so that the virtual images may be inserted into frames according to their priorities.

For example, when a first advertisement image having a first rating, a second advertisement image having a second rating, a first viewer image having a second rating, a second viewer image having a third rating, a broadcaster image having a third rating are received, the first advertisement image, the first viewer image, the second advertisement image, the second viewer image, and the broadcaster image may be respectively inserted into frames in the stated order, but the present disclosure is not limited thereto, and priorities may be determined in various ways.

The virtual image inserter 530 may respectively insert determined virtual images into broadcast content frames based on 3D coordinate information of an insertion region, which is obtained by the insertion region determiner 510. Accordingly, a virtual image may be appropriately inserted according to an insertion region that is transformed in real-time.

Moreover, the block diagrams shown in FIGS. 4 through 6 are provided for illustration of an embodiment. Each of the components in each block diagram may be integrated, added, or omitted according to the specification of the first device 200 that is actually implemented. In other words, two or more components may be combined into a single component, or a single component may be split into two or more components when necessary. Functions performed by each block are intended to describe embodiments, and a specific operation or device related to the functions does not limit the scope of the present disclosure.

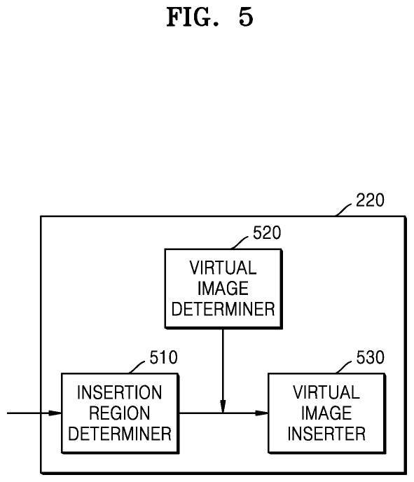

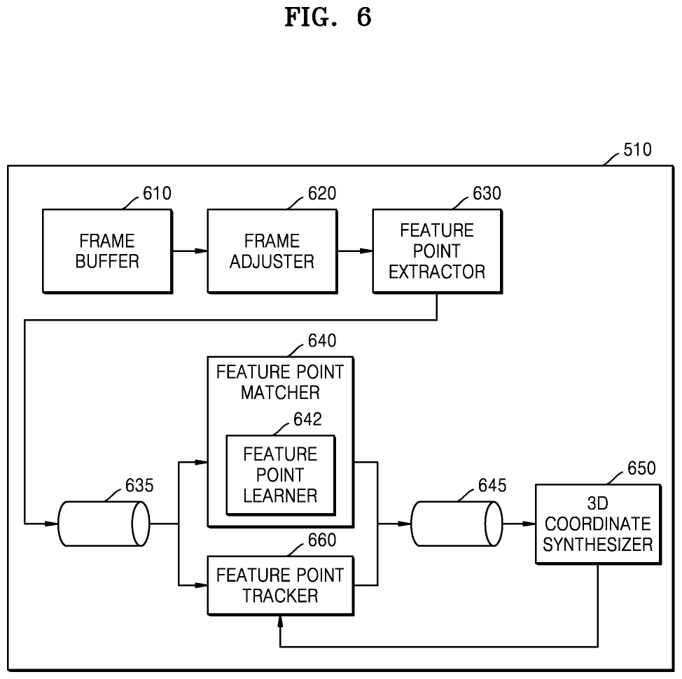

FIG. 7 is a flowchart of a method of inserting a virtual image into broadcast content, according to an embodiment.

Referring to FIG. 7, a first device 200 according to an embodiment may be a device used by a broadcaster to produce broadcast content. The broadcaster may log in to the virtual image intermediating system 100 by using the first device 200 (S710).

When the broadcaster logs in to the virtual image intermediating system 100, the first device 200 may transmit identification information (user information) of the broadcaster to the virtual image intermediating system 100 (S720).

Moreover, the virtual image intermediating system 100 may receive virtual images from a second device 300 (S701). The second device 300 according to an embodiment may be a device used by advertisers to upload advertisement images (advertising content), or a device used by a viewer to upload a virtual image while watching broadcast content. According to an embodiment, the second device 300 may log in to the virtual image intermediating system 100 to upload virtual images thereto.

Furthermore, the virtual images may include an advertisement image or an image uploaded by the viewer (hereinafter, referred to as a viewer image). While FIG. 7 shows that the operation (S701) of receiving the virtual images precedes the operation (S720) of receiving the user information from the first device 200, the present disclosure is not limited thereto, and operation S720 may be performed before operation S701.

The virtual image intermediating system 100 may extract, based on the received user information, information about the broadcaster and information about broadcast content broadcast by the broadcaster, and determine virtual images that are matched with the broadcast content based on the information about the broadcaster and the information about the broadcast content (S730).

For example, the virtual image intermediating system 100 may determine an advertisement image matched with the broadcast content based on rating information of the broadcaster, rating information of an advertiser, category information of the broadcast content, and category information of the advertisement image. Furthermore, the virtual image intermediating system 100 may match an image (viewer image) being transmitted by a viewer during broadcasting with broadcast content being viewed by the viewer.

Moreover, the virtual image intermediating system 100 may obtain an advertisement image via an external advertisement server. For example, the virtual image intermediating system 100 may request an advertisement image from an external advertisement server, and in this case, transmit information about a broadcaster and information about broadcast content together to the external advertisement server together.

According to an embodiment, the external advertisement server may include an ad exchange (ADX) that intermediates, via bidding, a transaction between a demand-side platform (DSP) and a supply-side platform (SSP) of an advertising site. Alternatively, it may include an advertisement network that receives advertisement bids through programmatic buying, but is not limited thereto.

The external advertisement server may transmit an advertisement image that is insertable into broadcast content to the virtual image intermediating system 100. The virtual image intermediating system 100 may receive the advertisement image from the external advertisement server and match the advertisement image with broadcast content based on rating information of a broadcaster, rating information of an advertiser, category information of the broadcast content, and category information of the advertisement image.

The virtual image intermediating system 100 may determine ratings for the virtual images (S740). For example, the virtual image intermediating system 100 may determine ratings for the advertisement images based on advertising fee information corresponding to each advertisement image, rating information of an advertiser, category information of each advertisement image, etc., but the present disclosure is not limited thereto. In addition, the virtual image intermediating system 100 may determine ratings for viewer images based on rating information and payment information of a viewer, which correspond to each viewer image, but the present disclosure is not limited thereto.

The virtual image intermediating system 100 may transmit, to the first device 200, the virtual images and information about the virtual images (e.g., rating information of each of the virtual images, etc.) (S750).

The first device 200 may determine priorities of virtual images (advertisement images and viewer images) received from the virtual image intermediating system 100. Furthermore, the first device 200 may also determine a priority of a virtual image uploaded by the broadcaster. The first device 200 may determine a virtual image to be inserted into the frame in the broadcast content according to a priority (S760), and insert the determined virtual image into the frame (S770).

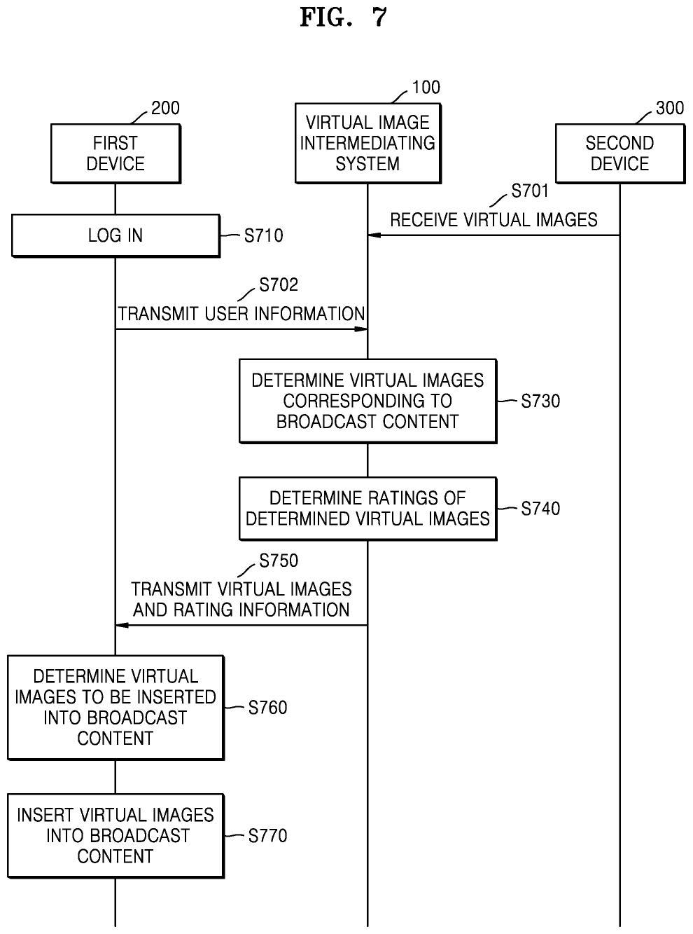

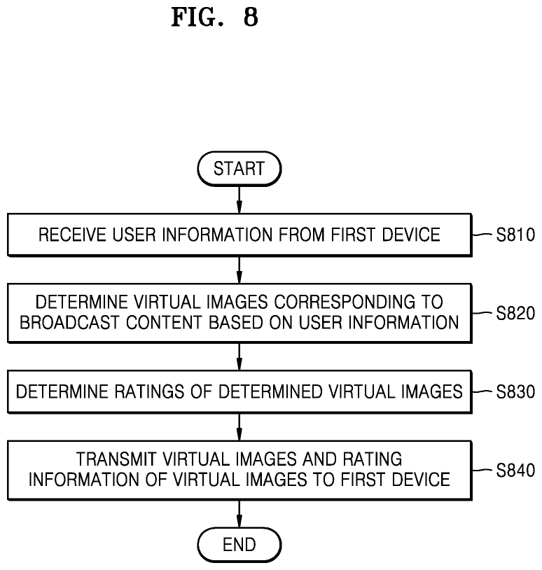

FIG. 8 is a flowchart of a method, performed by a virtual image intermediating system, of intermediating a virtual image, according to an embodiment.

Referring to FIG. 8, the virtual image intermediating system 100 may receive user information from a first device 200 (S810). The first device 200 may be a device used by a broadcaster to produce broadcast content.

For example, the virtual image intermediating system 100 may extract, based on the received user information, prestored information about a broadcaster and prestored information about broadcast content that is broadcast by the broadcaster. Alternatively, the virtual image intermediating system 100 may receive, from the first device 200, information of a broadcaster and information about broadcast content into which a virtual image is to be inserted. The information about the broadcast content may include at least one of a type of the broadcast content, information about a category of the broadcast content, information about a target user of the broadcast content, and information about the number of viewers of the broadcast content.

The virtual image intermediating system 100 may determine virtual images matched with broadcast content based on information about a broadcaster and information about the broadcast content (S820) and determine ratings for the virtual images (S830).

The virtual image intermediating system 100 may transmit, to the first device 200, the virtual images and information about the virtual images (e.g., rating information of each of the virtual images, etc.) (S840).

Because operations S820, S830, and S840 of FIG. 8 respectively correspond to operations S730, S740, and S750 of FIG. 7, descriptions already provided above with respect to FIG. 7 will be omitted herein.

FIG. 9 is a flowchart of a method, performed by a first device, of inserting a virtual image into broadcast content, according to an embodiment.

A first device 200 according to an embodiment may be a device used by a broadcaster to produce broadcast content or a virtual image insertion device for inserting a virtual image.

Referring to FIG. 9, according to an embodiment, the first device 200 may obtain information about an insertion region into which a virtual image is to be inserted (S910).

According to an embodiment, an insertion region into which a virtual image is to be inserted may be set on an object that is transformed in real-time. A broadcaster may capture an image of a preset template after placing the preset template on an object. For example, the broadcaster may capture an image of a preset template by attaching the preset temple on his or her T-shirt. In this case, the preset template and the captured image of the preset template may each include feature points, and feature points included in the preset template may be pre-learned and mapped to 3D coordinate values. For example, the first device 200 may obtain a plurality of template images captured by transforming a preset template into various forms, extract feature points from the template images, and learn 3D coordinate information of the extracted feature points.

The first device 200 may extract an insertion region for each of frames in broadcast content. For example, the first device 200 may extract at least one feature point from a frame and match the extracted at least one feature point to pre-learned feature points in a template image. Accordingly, the first device 200 may obtain 3D coordinate information (e.g., 3D mesh coordinates) for an insertion region extracted from each of the frames.

Alternatively, instead of using an image of a preset template, the broadcaster may set, as an insertion region, an arbitrary region on an object included in a frame. Feature points included in the set insertion region may be pre-learned and mapped to 3D coordinate values. The first device 200 may extract at least one feature point from a frame and match the extracted at least one feature point to pre-learned feature points. Accordingly, the first device 200 may obtain 3D coordinate information (e.g., 3D mesh coordinates) for an insertion region extracted from each of the frames.

The first device 200 may determine one or more virtual images to be inserted (S920).

For example, the first device 100 may determine one or more virtual images to be inserted into an insertion region from among advertisement images and viewer images received from the virtual image intermediating system 100 and virtual images uploaded by the broadcaster. For example, the first device 200 may determine a virtual image to be inserted based on a user input.

Alternatively, the first device 200 may determine priorities of virtual images and determine a virtual image to be inserted into a current frame based on the priorities thereof.

The first device 200 may respectively insert the determined virtual images into frames in real-time, based on information about an insertion region (e.g., 3D coordinate information) (S930).

The first device 200 may transmit in real-time the frames into which the virtual images are inserted to a broadcast content server.

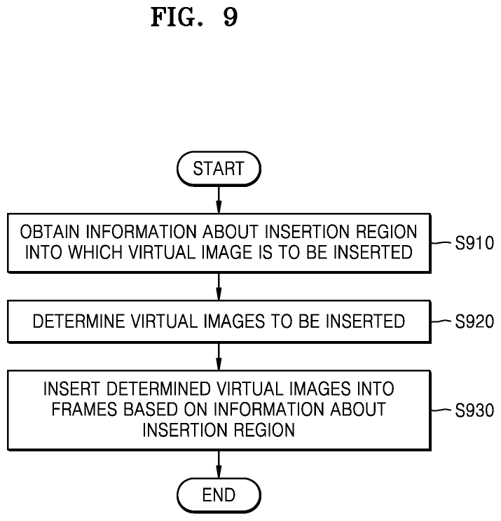

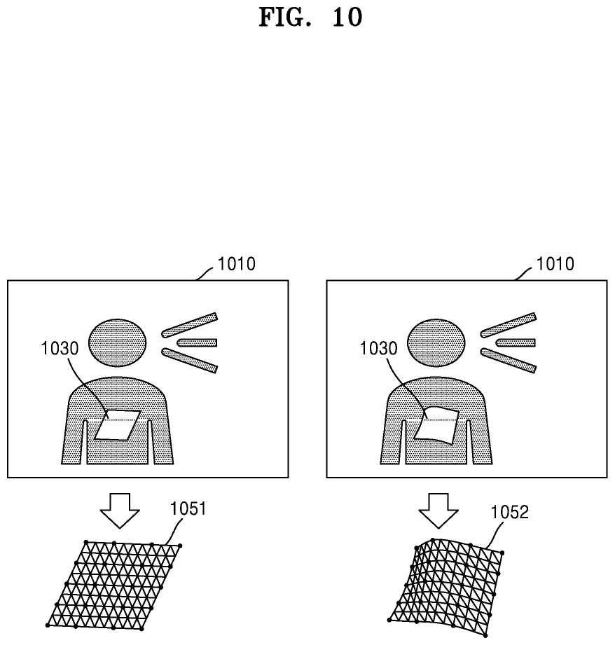

FIG. 10 is a reference diagram for describing an insertion region into which a virtual image is inserted, according to an embodiment.

Referring to FIG. 10, an insertion region 1030 according to an embodiment may be set on an object that is transformed in real-time. For example, the insertion region 1030 may be set on a broadcaster's T-shirt. In this case, each time the broadcaster moves, a location and a shape of the T-shirt may change accordingly on a frame in the broadcast content. For example, as the location and shape of the T-shirt change, a shape and a location of the insertion region 1030 set on the T-shirt may also vary for each frame in the broadcast content.

For example, when the insertion region 1030 has a first shape and is located at a first point in a first frame 1010, the insertion region 1030 may have a second shape and be located at a second point in a second frame 1020.

According to an embodiment, the first device 200 may extract at least one feature point included in the insertion region 1030 from the first frame 1010. The first device 200 may obtain 3D coordinate information 1051 corresponding to the insertion region 1030 based on the extracted at least one feature point. Furthermore, the first device 200 may extract at least one feature point included in the insertion region 1030 from the second frame 1020, and obtain 3D coordinate information 1052 corresponding to the insertion region 1030 based on the extracted at least one feature point.

According to an embodiment, the first device 200 may insert a virtual image based on 3D coordinate information corresponding to an insertion region.

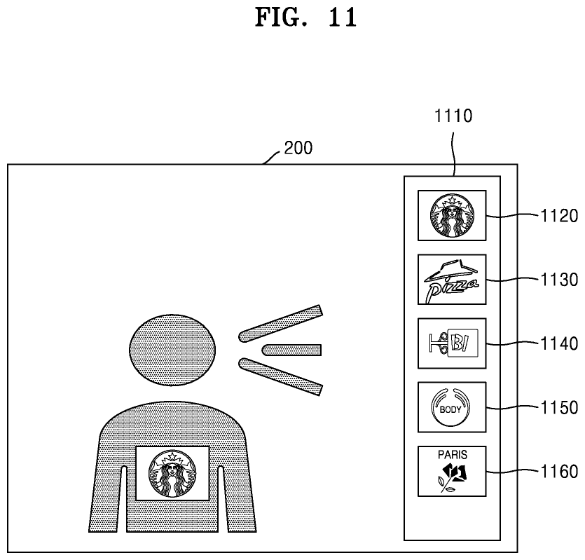

FIG. 11 is a reference diagram for describing a method of determining a virtual image to be inserted into an insertion region, according to an embodiment.

Referring to FIG. 11, the first device 200 may receive advertisement images or viewer images from the virtual image intermediating system 100. Furthermore, the first device 200 may also receive rating information of the advertisement images or viewer images.

The first device 200 may display the received advertisement images or viewer images as a virtual image list 1110. In addition, the first device 200 may display images uploaded by a broadcaster together in the virtual image list 1110.

For example, the virtual image list 1110 may include a first advertisement image 1120, a second advertisement image 1130, a first viewer image 1140, a second viewer image 1150, and an image 1160 uploaded by the broadcaster (an uploaded image).

In this case, the order that virtual images are displayed in the virtual image list 1110 may be determined based on rating information of the virtual images. For example, the higher the rating of a virtual image, the higher the virtual image displayed in the virtual image list 1110, but the present disclosure is not limited thereto.

In addition, the first device 200 may determine priorities of the virtual images based on the rating information of the virtual images, and respectively insert the virtual images into frames according to their priorities. For example, when a rating of the first advertisement image 1120 is higher than a rating of the second viewer image 1150, the first advertisement image 1120 may be inserted into a frame at time point t, and the second viewer image 1150 may be inserted into a frame at a time point later than the time point t, but the present disclosure is not limited thereto.

Alternatively, the first device 200 may determine the priorities of the virtual images according to a preset criterion. For example, the first device 200 may set a priority of an advertisement image or viewer image to be higher than that of an image uploaded by the broadcaster.

Furthermore, the first device 200 may insert the virtual images into frames in broadcast content in the order that they are displayed in the virtual image list 1110. For example, when the first advertisement image 1120 is displayed above the second advertisement image 1130, the first advertisement image 1120 may be inserted into a frame at time point t, and the second advertisement image 1130 may be inserted into a frame at a time point later than the time point t, but the present disclosure is not limited thereto.

Alternatively, the first device 200 may insert virtual images into frames according to priorities of the virtual images.

In addition, the first device 200 may determine a virtual image to be inserted into a frame based on a user input. For example, when the broadcaster selects the first viewer image 1140 from among the virtual images included in the virtual image list 1110, the first device 200 may insert the first viewer image 1140 into a frame.

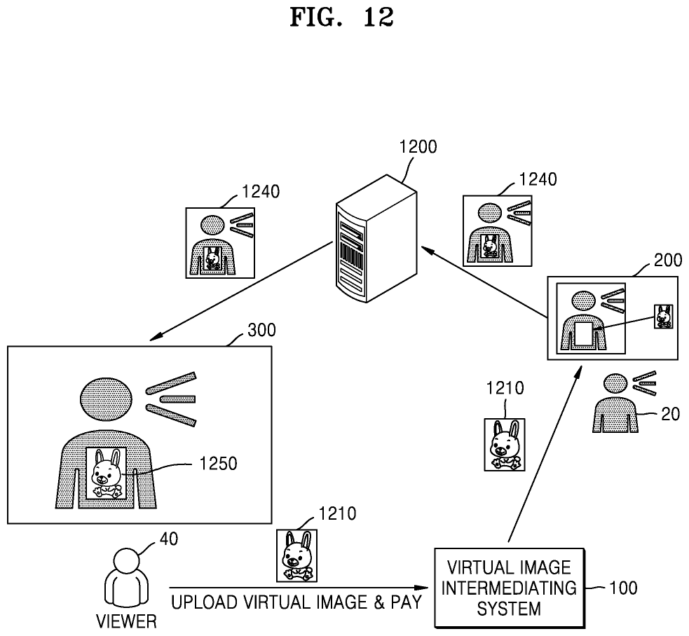

FIG. 12 is a reference diagram for describing a method of performing a real-time interaction between a broadcaster and a viewer by using a virtual image intermediating system, according to an embodiment.

According to an embodiment, a broadcaster 20 may produce broadcast content and provide it to a viewer in real-time. A viewer 40 may view broadcast content via a second device 300. An insertion region 1250 for inserting a virtual image may be set in the broadcast content. Moreover, in order to insert a virtual image 1210 into broadcast content that the viewer 40 is watching, the viewer 40 may transmit (upload) the virtual image 1210 to the virtual image intermediating system 100 by using the second device 300. In this case, the viewer 40 may pay for insertion of a virtual image by using the virtual image intermediating system 100.

The virtual image intermediating system 100 may transmit the virtual image 1210 transmitted from the viewer 40 to the first device 200 of the broadcaster 20.

According to an embodiment, the insertion region 1250 may be set on an object that is transformed in real-time, and accordingly, the first device 200 may obtain 3D coordinate information of the insertion region 1250 in each frame. The first device 200 may insert the virtual image 1210 transmitted by the viewer 40 into a frame based on the 3D coordinate information.

A frame 1240 into which the virtual image 1210 transmitted by the viewer 40 is inserted may be transmitted to a broadcast content server 1200 and be provided to the viewer 40 via the broadcast content server 1200. Accordingly, the viewer 40 may watch broadcast content into which a virtual image is inserted, and interact with the broadcaster 20 in real-time.

In this way, because the viewer may insert an image into broadcast content in real-time while watching a broadcast, an interaction between the viewer 40 and the broadcaster 20 may be reflected in the broadcast content. Thus, the interaction between the viewer and the broadcaster may be further strengthened.

An operation method of a virtual image intermediating system and an operation method of a virtual image insertion device according to embodiments may be implemented in the form of program instructions that may be performed by various types of computers and may be recorded on computer-readable recording media. The computer-readable recording media may include program instructions, data files, data structures, etc. either alone or in combination. The program instructions recorded on the computer-readable recording media may be designed and configured specially for the present disclosure or may be known to and be usable by those skilled in the art of computer software. Examples of the computer-readable recording media include magnetic media such as hard disks, floppy disks, and magnetic tapes, optical media such as compact disk read only memory (CD-ROM) and digital versatile disks (DVDs), magneto-optical media such as floptical disks, and hardware devices that are specially configured to store and perform program instructions, such as ROM, random access memory (RAM), flash memory, etc. Examples of program instructions include not only machine code such as that created by a compiler but also higher level language code that may be executed by a computer using an interpreter or the like.

In addition, the operation method of the virtual image intermediating system and the operation method of the virtual image insertion device according to the embodiments of the disclosure may be included in a computer program product when provided. The computer program product may be traded, as a commodity, between a seller and a buyer.

The computer program product may include a software program and a computer-readable storage medium having stored the software program thereon. For example, the computer program product may include a product (e.g., a downloadable application) in the form of a software program electronically distributed by a manufacturer of an electronic device or through an electronic market (e.g., Google™ Play Store™, and App Store™). For such electronic distribution, at least a part of the software program may be stored on the storage medium or may be temporarily generated. In this case, the storage medium may be a storage medium of a server of the manufacturer, a server of the electronic market, or a relay server for temporarily storing the software program.

In a system consisting of a server and a client device, the computer program product may include a storage medium of the server or a storage medium of the client device. Alternatively, in a case where a third device (e.g., a smartphone) communicatively connected to the server or client device is present, the computer program product may include a storage medium of the third device. Alternatively, the computer program product may include a software program itself that is transmitted from the server to the client device or the third device or that is transmitted from the third device to the client device.

In this case, one of the server, the client device, and the third device may execute the computer program product to perform methods according to embodiments of the disclosure. Alternatively, at least two of the server, the client device, and the third device may execute the computer program product to perform the methods according to the embodiments of the disclosure in a distributed manner.

For example, the server (e.g., a cloud server, an artificial intelligence (AI) server, or the like) may execute the computer program product stored in the server to control the client device communicatively connected to the server to perform the methods according to the embodiments of the disclosure.

While embodiments have been particularly described above, the embodiments are not to be construed as limiting the scope of the present disclosure, and various changes and improvements made by those of ordinary skill in the art based on a basic concept of the present disclosure also fall within the scope of the present disclosure as defined by the following claims.

1. A system for intermediating a virtual image, the system comprising:
a communicator configured to receive, from a first device, user information and information about broadcast content into which a virtual image is to be inserted and receive virtual images from a second device;
a memory storing one or more instructions; and
a processor configured to execute the one or more instructions stored in the memory to:
determine, based on the user information and the information about the broadcast content, one or more virtual images that are insertable into the broadcast content from among the virtual images; and control the communicator to transmit the determined one or more virtual images to the first device.

2. The system of claim 1, wherein the virtual images include at least one of an advertisement image transmitted by an advertiser and an image transmitted by a viewer who watches the broadcast content.

3. The system of claim 2, wherein the processor is further configured to execute the one or more instructions to determine whether the advertisement image is insertable into the broadcast content, based on advertiser information and advertisement image information corresponding to the advertisement image.

4. The system of claim 2, wherein the processor is further configured to execute the one or more instructions to determine, based on information about the one or more virtual images that are insertable into the broadcast content, a rating of the one or more virtual images, and control the communicator to transmit information about the rating of the one or more virtual images to the first device.

5. The system of claim 4, wherein the processor is further configured to execute the one or more instructions to determine a rating of the advertisement image based on the advertiser information and advertisement image information corresponding to the advertisement image.

6. The system of claim 4, wherein the processor is further configured to execute the one or more instructions to determine a rating of the image transmitted by the viewer based on payment information corresponding to the image transmitted by the viewer.

7. An operation method of a system for intermediating a virtual image, the operation method comprising:
receiving, from a first device, user information and information about broadcast content into which a virtual image is to be inserted;
receiving virtual images from a second device;
determining, based on the user information and the information about the broadcast content, one or more virtual images that are insertable into the broadcast content from among the virtual images; and
transmitting the determined one or more virtual images to the first device.

8. The operation method of claim 7, wherein the virtual images include at least one of an advertisement image transmitted by an advertiser and an image transmitted by a viewer who watches the broadcast content.

9. The operation method of claim 8, wherein the determining of the one or more virtual images that are insertable into the broadcast content comprises determining whether the advertisement image is insertable into the broadcast content, based on advertiser information and advertisement image information corresponding to the advertisement image.

10. The operation method of claim 8, further comprising:
determining, based on information about the one or more virtual images that are insertable into the broadcast content, a rating of the one or more virtual images; and
transmitting information about the rating of the one or more virtual images to the first device.

11. The operation method of claim 10, wherein the determining of the rating of the one or more virtual images comprises determining a rating of the advertisement image based on the advertiser information and advertisement image information corresponding to the advertisement image.

12. The operation method of claim 10, wherein the determining of the rating of the one or more virtual images comprises determining a rating of the image transmitted by the viewer based on payment information corresponding to the image transmitted by the viewer.
